(19) United States
(12) Patent Application Publication
(10) Pub. No.: US 2010/0235626 A1
(43) Pub. Date: Sep. 16, 2010

(54) APPARATUS AND METHOD FOR MUTUAL AUTHENTICATION IN DOWNLOADABLE CONDITIONAL ACCESS SYSTEM

(76) Inventors: Eun Jung KWON, Daejeon (KR); Han Seung KOO, Daejeon (KR); Soon Choul KIM, Daejeon (KR); Heejeong KIM, Daejeon (KR); Young Ho JEONG, Daejeon (KR); O Hyung KWON, Daejeon (KR); Soo In LEE, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/719,928

(22) Filed: Mar. 9, 2010

(30) Foreign Application Priority Data
Mar. 10, 2009 (KR) 10-2009-0020127
Dec. 9, 2009 (KR) 10-2009-0121881

(51) Int. Cl. H04L 9/32; H04N 7/167

(52) U.S. Cl. 713/156; 713/169; 713/155; 380/259; 380/210

(57) ABSTRACT

A mutual authentication apparatus in a Downloadable Conditional Access System (DCAS) includes an announce protocol processor to authenticate SecurityAnnounce information using an Authentication Proxy (AP) and to transmit the authenticated SecurityAnnounce information to a Secure Micro (SM), a keying protocol processor to relay KeyRequest information and KeyResponse information between a Trusted Authority (TA) and the SM in response to the SecurityAnnounce information, a decryption unit to decrypt the KeyResponse information using the SM, an authentication protocol processor to determine whether a first encryption key of the KeyResponse information is identical to a second encryption key generated by the AP, and a download protocol processor to control DownloadInfo to be transmitted from the AP to the SM, the DownloadInfo permitting the SM to download SM Client Image information.

### BACKGROUND OF THE INVENTION

1. Field of the Invention

The present invention relates to a mutual authentication apparatus and method in a Downloadable Conditional Access System (DCAS).

This work was supported by the IT R&D program of MIC/IITA. [2007-S-007-03, The Development of Downloadable Conditional Access System]

2. Description of the Related Art

A Conditional Access System (CAS) provides a broadcast program of a fee-based broadcasting service only to subscribers allowed to view the broadcast program, by using a password. To provide the fee-based broadcasting service, the CAS may use a cable card such as a smart card or a Personal Computer Memory Card International Association (PCMCIA) depending on an implementation fowl of a Conditional Access (CA) application.

Currently, a Downloadable Conditional Access System (DCAS) based on an interactive communication network is being developed. In the DCAS, a security module where CAS software is installed may be mounted in a set-top box (STB) and thus, the CAS software may be easily updated through the interactive communication network, when an error in the CAS software is to be addressed or when a version update of the CAS software is required.

When CAS software is transmitted to an STB of an unauthenticated subscriber, the DCAS may illegally provide a fee-based broadcasting service to the unauthenticated subscriber, or may lead to an unexpected result. Thus, there is a demand to perform a mutual authentication between an authentication server and a security module to be mounted in an STB.

Also, when a security module to be mounted in an STB does not authenticate an authentication proxy located in a headend, the security module may be attacked by a third-party server masquerading as the authentication proxy.

Accordingly, an effective mutual authentication method is required to overcome such security problems in a DCAS.

### SUMMARY OF THE INVENTION

According to an aspect of the present invention, there is provided a mutual authentication apparatus in a Downloadable Conditional Access System (DCAS), the mutual authentication apparatus including: an announce protocol processor to authenticate SecurityAnnounce information using an Authentication Proxy (AP), and to transmit the authenticated SecurityAnnounce information to a Secure Micro (SM); a keying protocol processor to relay KeyRequest information and KeyResponse information between a Trusted Authority (TA) and the SM, in response to the SecurityAnnounce information; a decryption unit to decrypt the KeyResponse information using the SM; an authentication protocol processor to determine whether a first encryption key of the KeyResponse information is identical to a second encryption key generated by the AP; and a download protocol processor to control DownloadInfo to be transmitted from the AP to the SM, the DownloadInfo being used to permit the SM to download SM Client Image information.

According to another aspect of the present invention, there is provided a mutual authentication method in a DCAS, the mutual authentication method including: authenticating SecurityAnnounce information using an AP and transmitting the authenticated SecurityAnnounce information to an SM; relaying KeyRequest information and KeyResponse information between a TA and the SM, in response to the SecurityAnnounce information; decrypting the KeyResponse information using the SM; determining whether a first encryption key of the KeyResponse information is identical to a second encryption key generated by the AP; and controlling DownloadInfo to be transmitted from the AP to the SM, the DownloadInfo being used to permit the SM to download SM Client Image information.

### BRIEF DESCRIPTION OF THE DRAWINGS

The above and other aspects of the present invention will become apparent and more readily appreciated from the following detailed description of certain exemplary embodiments of the invention, taken in conjunction with the accompanying drawings of which:

FIG. 1 is a block diagram illustrating a configuration of a Downloadable Conditional Access System (DCAS) according to an embodiment of the present invention;

FIG. 2 is a diagram illustrating layers of a network communication architecture on a cable network according to an embodiment of the present invention;

FIG. 3 is a block diagram illustrating a configuration of a mutual authentication apparatus in a DCAS according to an embodiment of the present invention;

FIG. 4 is a flowchart illustrating a mutual authentication method in a DCAS according to an embodiment of the present invention;

FIG. 5 is a flowchart illustrating decryption and authentication operations according to an embodiment of the present invention; and

FIG. 6 is a flowchart illustrating a method of generating a message encryption key and an SM Client Image encryption key according to an embodiment of the present invention.

### DETAILED DESCRIPTION OF EXEMPLARY EMBODIMENTS

Reference will now be made in detail to exemplary embodiments of the present invention, examples of which are illustrated in the accompanying drawings, wherein like reference numerals refer to the like elements throughout. The exemplary embodiments are described below in order to explain the present invention by referring to the figures.

When detailed descriptions related to a well-known related function or configuration are determined to make the spirits of the present invention ambiguous, the detailed descriptions will be omitted herein. Also, terms used throughout the present specification are used to appropriately describe exemplary embodiments of the present invention, and thus may be different depending upon a user and an operator's intention, or practices of application fields of the present invention. Therefore, the terms must be defined based on descriptions made through the present invention.

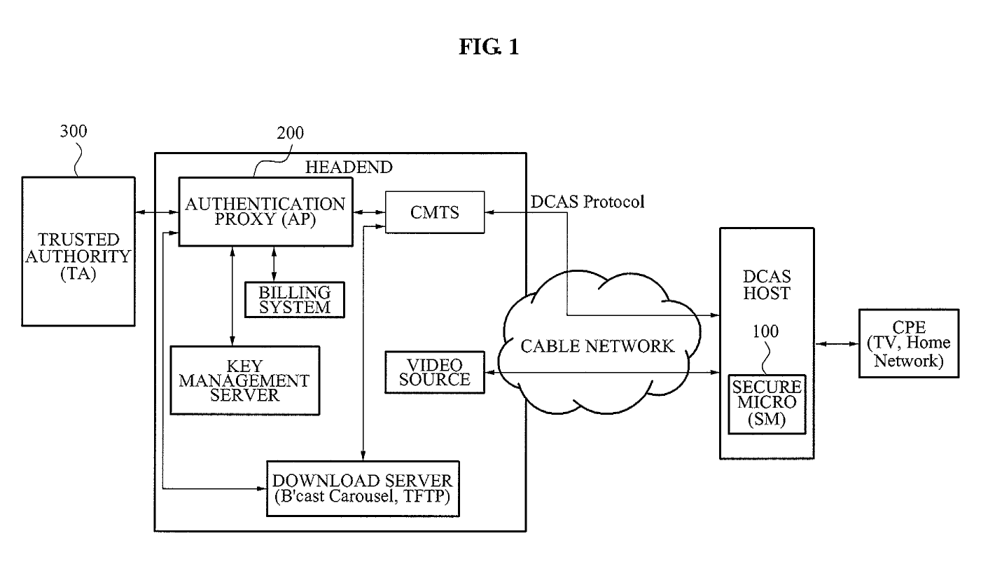

FIG. 1 is a block diagram illustrating a configuration of a Downloadable Conditional Access System (DCAS) according to an embodiment of the present invention.

The DCAS of FIG. 1 may provide a mutual authentication method between a Secure Micro (SM) 100 and an Authentication Proxy (AP) 200, as described above.

A mutual authentication apparatus according to an embodiment of the present invention may include the SM 100 of a DCAS host, the AP 200 of a headend, and a Trusted Authority (TA) 300 connected to the AP 200.

As shown in FIG. 1, the SM 100 and the AP 200 may interactively communicate with each other through a cable network.

The SM 100 and the AP 200 may use a third party, namely TA 300, rather than using a cable operator to manage information used for authentication. The TA 300 may provide a variety of important information used for authentication through the AP 200.

The AP 200 may transmit information used for authentication received from the TA 200 to the SM 100 through a Cable Modem Termination System (CMTS). All types of key information generated during the authentication may be managed by a key management server. When the authentication is normally completed, Conditional Access System (CAS) software may be transmitted to the SM 100 through a download server and the CMTS.

After downloading the CAS software, the SM 100 may obtain viewing entitlement with respect to a scrambled and transmitted broadcasting signal, and may provide a subscriber with a fee-based broadcasting service through Customer Premise Equipment (CPE).

According to an embodiment of the present invention, a communication mechanism associated with a standard and process with respect to messages transceiving among the SM 100, the AP 200 and the TA 300 may be defined as a DCAS protocol. The DCAS protocol may enable a security and authentication function for messages transceiving among the SM 100, the AP 200 and the TA 300.

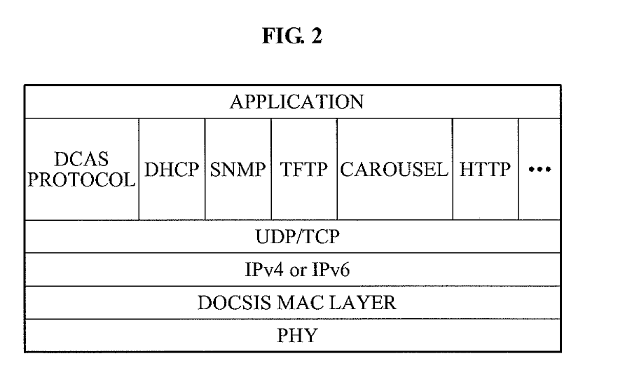

FIG. 2 is a diagram illustrating layers of a network communication architecture on a cable network according to an embodiment of the present invention.

As illustrated in FIG. 2, the DCAS protocol may be controlled to be operated via the cable network, independent of a Data Over Cable Service Interface Specification (DOCSIS) layer, an Internet Protocol (IP) layer, and a Transmission Control Protocol/User Datagram Protocol (TCP/UDP) layer.

Also, main functions of the DCAS protocol may include performing a mutual authentication between the SM 100 and the AP 200 in advance, to stably transmit the CAS software to the SM 100.

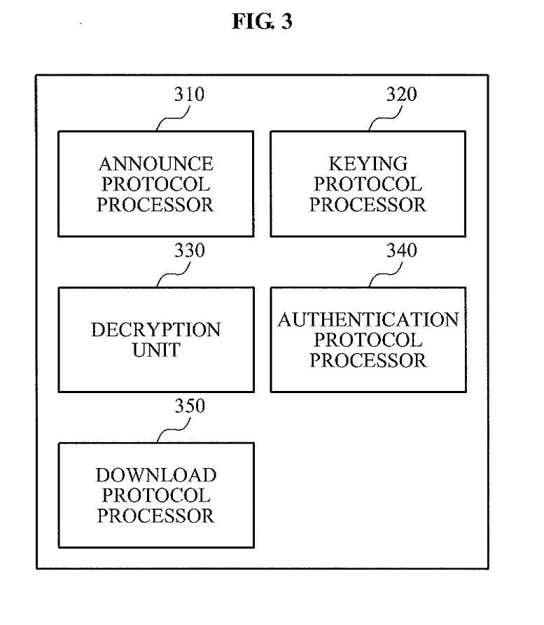

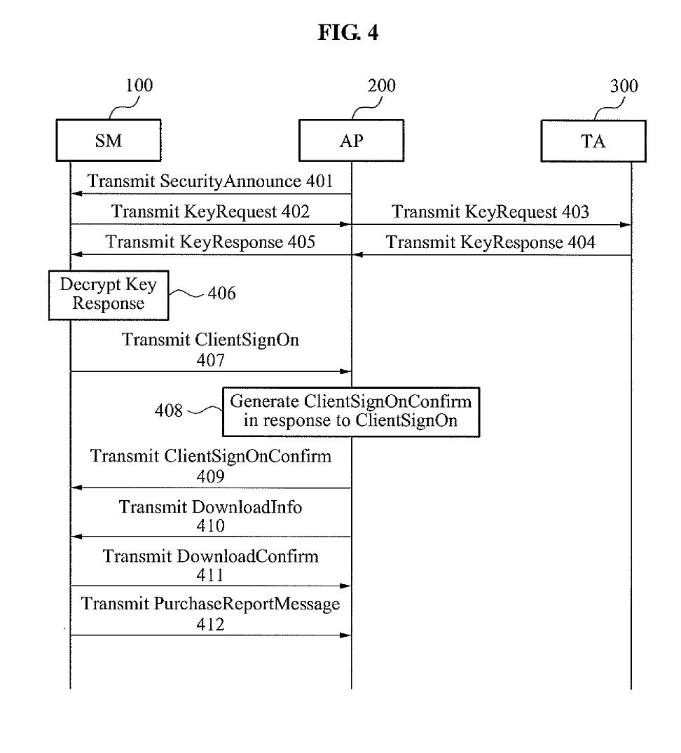

Hereinafter, a method of performing the mutual authentication between the SM 100 and the AP 200 in the DCAS will be further described with reference to FIGS. 3 and 4.

FIG. 3 is a block diagram illustrating a configuration of a mutual authentication apparatus in the DCAS, and FIG. 4 is a flowchart illustrating a mutual authentication method in the DCAS.

According to an embodiment of the present invention, it is assumed that, prior to a network protocol operation, the SM 100, the AP 200 and the TA 300 include information that will be described below.

According to another embodiment of the present invention, when the TA 300 is moved in the headend, a Local Key Server (LKS) may perform the function of the TA 300, instead of the TA 300.

The SM 100 is assumed to retain a TA certificate (TA X.509 Certificate), an SM certificate, a Ki value, and three Operator Variant Algorithm Configuration Field (OP).

The AP 200 is assumed to retain a TA certificate (TA X.509 Certificate), and an AP certificate (AP X.509 Certificate).

The TA 300 is assumed to retain a TA certificate (TA X.509 Certificate), an AP certificate (AP X.509 Certificate), an SM certificate, three OP, a Ki value, and a key paring identifier (ID).

Under the above assumptions, the mutual authentication apparatus of FIG. 3 includes an announce protocol processor 310, a keying protocol processor 320, an authentication protocol processor 340, and a download protocol processor 350.

The announce protocol processor 310 may control the AP 200 to transmit SecurityAnnounce information to the SM 100 in operation 401.

In this instance, the announce protocol processor 310 may authenticate the SecurityAnnounce information using the AP 200 by a Hashed Message Authentication Code (HMAC) scheme, and may transmit the authenticated SecurityAnnounce information to the SM 100 using a multicast scheme.

The SM 100 may perform an HMAC message authentication using a Common Hash Key (CHK). The HMAC message authentication may be performed to authenticate the SecurityAnnounce information received from the AP 200, and accordingly, the SM 100 may perform a key protocol process below.

In this instance, when the CHK of the SM 100 differs from that of the AP 200, or when the SM 100 is moved to an AP zone, or when the SM is in a virgin state where no CHK exists, the SM 100 may receive a CHK contained in the SecurityAnnounce information from the AP 200.

The keying protocol processor 320 may receive KeyRequest information from the SM 100 using the AP 200 in response to the SecurityAnnounce information, may transmit the received KeyRequest information to the TA 300, may receive KeyResponse information from the TA 300 in response to the KeyRequest information, and may transmit the received KeyResponse information to the SM 100, in operations 402 to 405.

Specifically, the keying protocol processor 320 may control the SM 100 to transmit, to the AP 200, the KeyRequest information digitally signed by a private key of the SM 100 in operation 402.

The keying protocol processor 320 may verify a Rivest-Shamir-Adleman (RSA) digital signature of the KeyRequest information using the AP 200, and may transmit new KeyRequest information to the TA 300 in operation 403. Here, the new KeyRequest information may be regenerated based on a key pairing ID and an AP ID extracted from the KeyRequest information.

The keying protocol processor 320 may search for an SM certificate based on the key pairing ID using the TA 300, may authenticate the SM 100 based on the SM certificate, may define a result of the authenticating of the SM 100 in the KeyResponse information, and may then transmit the KeyResponse information to the AP 200 in operation 404.

In this instance, when the SM 100 is in the virgin state, the TA 300 may perform a Transfer Protocol_Paring (TP_Paring) function. Alternatively, when the SM 100 is not in the virgin state, the TA 300 may perform a function of comparing the KeyResponse information with an initial paring value.

The keying protocol processor 320 may define an AP certificate in the KeyResponse information using the AP 200, and may transmit the KeyResponse information to the SM 100 in operation 405.

In this instance, when an authentication result value (Auth_Rst) about the KeyResponse infoiination is set as true, the AP 200 may generate a CHK and an Individual Hash Key (IHK) through a hash key generation process, and may add the generated CHK and IHK together with the AP certificate to the KeyResponse information. Also, the AP 200 may digitally sign the KeyResponse information using a private key of the AP 200, may encrypt a part of the digitally signed KeyResponse information using a public key of the SM 100, and may transmit the encrypted KeyResponse information to the SM 100.

A decryption unit 330 of the mutual authentication apparatus of FIG. 3 may decrypt the KeyResponse information using the SM 100 in operation 406.

The decryption unit 330 may decrypt one or more pieces of information contained in the KeyResponse information based on the AP certificate using the SM 100.

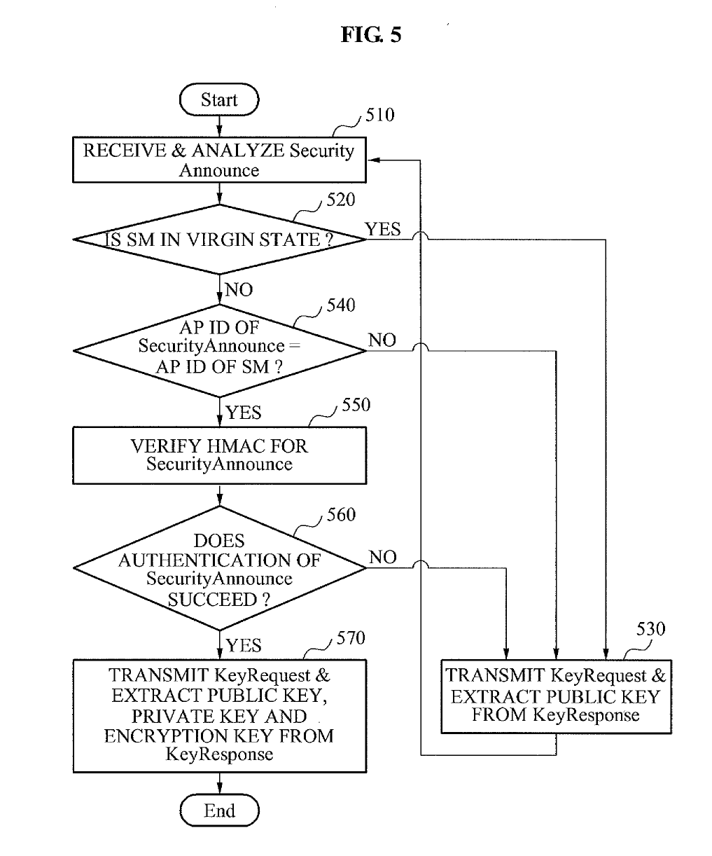

Also, the decryption unit 330 may include, for example, an updating unit and an authentication unit, and decryption and authentication operations will be described with reference to FIG. 5 below.

FIG. 5 is a flowchart illustrating decryption and authentication operations according to an embodiment of the present invention.

The SM 100 may receive the SecurityAnnounce information and analyze the received SecurityAnnounce information in operation 510. Also, the SM 100 may determine whether a current state is in the virgin state in operation 520.

In this instance, when the SM 100 is in the virgin state or when the SM 100 is moved to the AP zone, the updating unit of the decryption unit 330 may extract a newest CHK and update the original CHK, using the SM 100, in operation 530.

The SM 100 may determine whether an AP JD contained in the SecurityAnnounce information is identical to an AP ID contained in the SM 100 in operation 540. When determining that the two AP IDs are different, the SM 100 may perform operation 530.

However, when the SM 100 is not in the virgin state, or when the SM 100 is not moved to the AP zone, the authentication unit of the decryption unit 330 may perform the HMAC message authentication using the CHK retained in the SM 100 in operation 550.

Also, the SM 100 may determine whether authentication of the SecurityAnnounce information succeeds in operation 560. When the authentication of the SecurityAnnounce information is determined to fail, the SM 100 may perform operation 530.

Alternatively, when the authentication of the SecurityAnnounce information is determined to succeed, the SM 100 may transmit the KeyRequest information to the AP 200, and may extract a public key, a private key, and an encryption key from the KeyResponse information in operation 570.

The authentication protocol processor 340 may transmit, to the AP 200, ClientSignOn information containing a first encryption key of the KeyResponse information, may determine, using the AP 200, whether the first encryption key is identical to a second encryption key generated by the AP 200, and may control ClientSignOnConfirm information to be transmitted to the SM 100 in response to the ClientSignOn information when the first encryption key is determined to be identical to the second encryption key, in operations 407 to 409.

In this instance, the first encryption key may include a first message encryption key and a first SM Client Image encryption key which are generated based on the KeyResponse information through the SM 100. The second encryption key may include a second message encryption key and a second SM Client Image encryption key which are generated through the AP 200.

Specifically, the SM 100 may generate the first message encryption key and the first SM Client Image encryption key using a value defined in the KeyResponse information.

The SM 100 may also generate the ClientSignOn information so that the first message encryption key and the first SM Client Image encryption key may be generated by the AP 200.

In this instance, the SM 100 may add hash values for the first message encryption key and the first SM Client Image encryption key to the ClientSignOn information, may apply an HMAC to the ClientSignOn information using the private key defined in the KeyResponse information, and may then transmit, to the AP 200, the ClientSignOn information to which the HMAC is applied, in operation 407.

The AP 200 may receive the ClientSignOn information from the SM 100, and may perform the HMAC message authentication using the private key of the AP 200.

The AP 200 may determine whether the first message encryption key and the first SM Client Image encryption key hashed in the ClientSignOn information are identical to the second message encryption key and the second SM Client Image encryption key, and may perform the following operations.

When the first message encryption key and the first SM Client Image encryption key are determined to differ from the second message encryption key and the second SM Client Image encryption key, the AP 200 may transmit inconsistency information to the SM 100. Here, the inconsistency information may indicate that the first encryption key differs from the second encryption key.

Also, when the first message encryption key and the first SM Client Image encryption key are determined to be identical to the second message encryption key and the second SM Client Image encryption key, the AP 200 may transmit the ClientSignOnConfirm information to the SM 100 in operation 409.

In this instance, the ClientSignOnConfirm information may be encrypted and transmitted using an Advanced Encryption Standard (AES) algorithm with the encryption key and the IV.

The download protocol processor 350 may control DownloadInfo to be transmitted from the AP 200 to the SM 100 in operation 410. Here, the DownloadInfo may be used to permit the SM 100 to download SM Client Image information.

In this instance, after the HMAC message authentication is performed using the private key and a message is encrypted using the AES algorithm with the encryption key and the IV, the DownloadInfo may be transmitted to the SM 100.

The SM 100 may receive the DownloadInfo, may normally perform message authentication and decryption operations, and may download the SM Client Image information from a server in which the SM Client Image information is stored.

Since the SM Client Image information is encrypted using the AES algorithm with the encryption key and the IV, the SM 100 may decrypt the SM Client Image information using the encryption key and the IV.

The download protocol processor 350 may control DownloadConfirm information in response to the DownloadInfo to be transmitted from the SM 100 to the AP 200 in operation 411.

Also, when PurchaseReport_REQ is defined in the DownloadInfo, the SM 100 may apply the HMAC to PurchaseReportMessage using the private key, may encrypt the PurchaseReportMessage using the encryption key, and may transmit the encrypted PurchaseReportMessage to the AP 200 in operation 412.

Hereinafter, a description is given of an operation of generating hash keys, namely a CHK and an IHK, that are used for message authentication when the mutual authentication apparatus according to the embodiment of the present invention performs a DCAS authentication protocol between the SM 100 and the AP 200.

The CHK and the IHK may be generated by a Secure Hash Algorithm (SHA-1) hash function as follows. In this instance, random numbers RANDIHK and RANDCHK may be generated based on either hardware or software.

For example, the CHK and the IHK may be generated using a hardware version in compliance with Section 4.7.1 of the Federal Information Processing Standard (FIPS), or may be generated using a software version in compliance with FIPS 186-2 Appendix 3.3. When the CHK and the IHK are generated using the software random number generator, a seed value of the random number generator needs to be a secret value for a unique unit.

Hereinafter, a description is given of an operation of generating the first and second message encryption keys and the first and second SM Client Image encryption keys, which are used to encrypt messages and the SM Client Image information, when the DCAS authentication protocol between the SM 100 and the AP 200 is performed.

Here, the first and second message encryption keys may be symmetric keys used to encrypt messages transmitted between the SM 100 and AP 200 in the DCAS network protocol. Also, the first and second SM Client Image encryption keys may be symmetric keys used to encrypt the SM Client Image information.

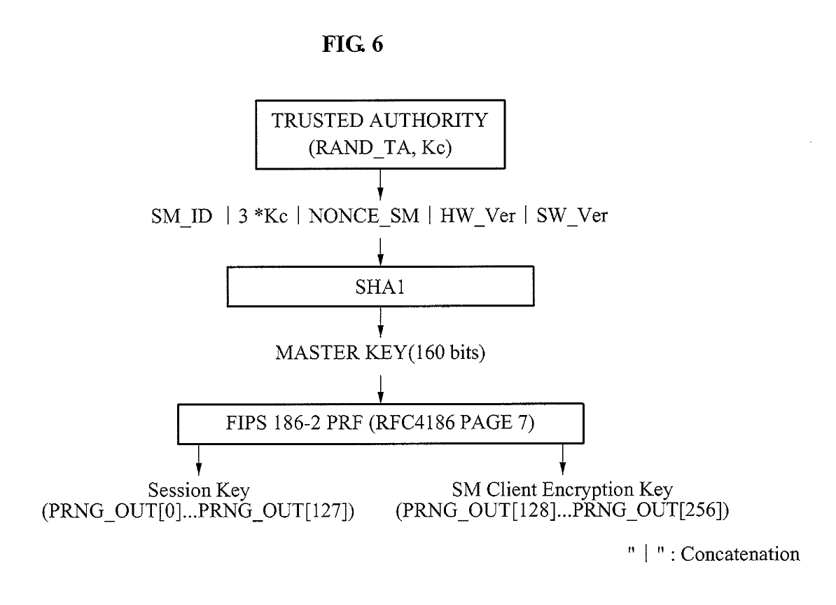

FIG. 6 is a flowchart illustrating a method of generating a message encryption key and an SM Client Image encryption key according to an embodiment of the present invention.

The message encryption key and the SM Client Image encryption key may have, for example, a key length of 128 bits, and may be generated by using an input of a Pseudo Random Number Generator (PRNG) as a Master Key (MK), as shown in FIG. 6.

Referring to FIG. 6, three Kc values among input values of the SHA-1 hash function means that three Kc are generated using three RAND values in RAND_TA received from an AP.

The PRNG may use a modification of Algorithm 1 defined in the FIPS 186-2, and may comply with an algorithm described in Appendix B of RFC4186.

According to the embodiments of the present invention, it is possible to provide a mutual authentication protocol between an AP and an SM.

Also, according to the embodiments of the present invention, it is possible to provide a mutual authentication apparatus to reduce operating costs incurred by unnecessary hardware-based entity authentication, and to rapidly update a system when an error is to be addressed.

Also, according to the embodiments of the present invention, it is possible to provide an effective authentication protocol to perform various sub security functions, for example encryption and decryption of traffic data, message authentication, and apparatus authentication during transmission of software in a DCAS.

The above-described embodiments of the present invention may be recorded in computer-readable media including program instructions to implement various operations embodied by a computer. The media may also include, alone or in combination with the program instructions, data files, data structures, and the like. The program instructions may be those specially designed and constructed, or they may be of the kind well-known and available to those having skill in the computer software arts. Examples of computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described example embodiments, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A mutual authentication apparatus in a Downloadable Conditional Access System (DCAS), the mutual authentication apparatus comprising:
an announce protocol processor to authenticate SecurityAnnounce information using an Authentication Proxy (AP), and to transmit the authenticated SecurityAnnounce information to a Secure Micro (SM);
a keying protocol processor to relay KeyRequest information and KeyResponse information between a Trusted Authority (TA) and the SM, in response to the SecurityAnnounce information;
a decryption unit to decrypt the KeyResponse information using the SM;
an authentication protocol processor to determine whether a first encryption key of the KeyResponse information is identical to a second encryption key generated by the AP; and
a download protocol processor to control DownloadInfo to be transmitted from the AP to the SM, the DownloadInfo being used to permit the SM to download SM Client Image information.

2. The mutual authentication apparatus of claim 1, wherein the keying protocol processor receives a Common Hash Key (CHK) contained in the SecurityAnnounce information from the AP using the SM.

3. The mutual authentication apparatus of claim 1, wherein the keying protocol processor transmits the KeyRequest information to the AP using the SM and transmits new KeyRequest information to the TA, the KeyRequest information being digitally signed by a private key of the SM, and the new KeyRequest information being regenerated based on a key pairing identifier (ID) and an AP ID extracted from the KeyRequest information using the AP.

4. The mutual authentication apparatus of claim 3, wherein the keying protocol process searches for an SM certificate based on the key pairing ID using the TA, authenticates the SM based on the SM certificate, defines a result of the authenticating of the SM in the KeyResponse information, and transmits the KeyResponse information to the AP.

5. The mutual authentication apparatus of claim 4, wherein the keying protocol processor defines an AP certificate in the KeyResponse information using the AP, and transmits the KeyResponse information to the SM.

6. The mutual authentication apparatus of claim 5, wherein the decryption unit decrypts one or more pieces of information contained in the KeyResponse information based on the AP certificate using the SM.

7. The mutual authentication apparatus of claim 6, wherein the decryption unit comprises:
an updating unit to extract a newest CHK and to update the CHK, when the SM is in a virgin state or when the SM is moved to an AP zone; and
an authentication unit to perform a Hashed Message Authentication Code (HMAC) message authentication using the CHK of the SM, when the SM is in a non-virgin state or when the SM is not moved to the AP zone.

8. The mutual authentication apparatus of claim 1, wherein the first encryption key comprises a first message encryption key and a first SM Client Image encryption key, the first message encryption key and the first SM Client Image encryption key being generated based on the KeyResponse information through the SM, and
the second encryption key comprises a second message encryption key and a second SM Client Image encryption key, the second message encryption key and the second SM Client Image encryption key being generated through the AP.

9. The mutual authentication apparatus of claim 8, wherein the first message encryption key and the second message encryption key are symmetric keys used to encrypt a message transmitted between the SM and AP, and
the first SM Client Image encryption key and the second SM Client Image encryption key are symmetric keys used to encrypt the SM Client Image information.

10. The mutual authentication apparatus of claim 9, wherein the first message encryption key, the second message encryption key, the first SM Client Image encryption key, and the second SM Client Image encryption key are generated by inputting a Pseudo Random Number Generator (PRNG) to a Master Key (MK).

11. The mutual authentication apparatus of claim 1, wherein, when the first encryption key differs from the second encryption key, the authentication protocol processor transmits inconsistency information to the SM using the AP, the inconsistency information indicating that the first encryption key differs from the second encryption key.

12. A mutual authentication method in a DCAS, the mutual authentication method comprising:
authenticating SecurityAnnounce information using an AP and transmitting the authenticated SecurityAnnounce information to an SM;
relaying KeyRequest information and KeyResponse information between a TA and the SM, in response to the SecurityAnnounce information;
decrypting the KeyResponse information using the SM;
determining whether a first encryption key of the KeyResponse information is identical to a second encryption key generated by the AP; and
controlling DownloadInfo to be transmitted from the AP to the SM, the DownloadInfo being used to permit the SM to download SM Client Image information.

13. The mutual authentication method of claim 12, further comprising:
receiving a CHK contained in the SecurityAnnounce information from the AP using the SM.

14. The mutual authentication method of claim 12, further comprising:
transmitting the KeyRequest information to the AP using the SM, the KeyRequest information being digitally signed by a private key of the SM; and
transmitting new KeyRequest information to the TA, the new KeyRequest information being regenerated based on a key pairing ID and an AP ID extracted from the KeyRequest information using the AP.

15. The mutual authentication method of claim 14, further comprising:
searching for an SM certificate based on the key pairing ID using the TA, and authenticating the SM based on the SM certificate;
defining a result of the authenticating of the SM in the KeyResponse information and transmitting the KeyResponse information to the AP.

16. The mutual authentication method of claim 15, further comprising:
defining an AP certificate in the KeyResponse information using the AP, and transmitting the KeyResponse information to the SM.

17. The mutual authentication method of claim 16, wherein the decrypting comprises decrypting one or more pieces of information contained in the KeyResponse information based on the AP certificate using the SM.

18. The mutual authentication method of claim 17, further comprising:
extracting a newest CHK and updating the CHK, when the SM is in a virgin state or when the SM is moved to an AP zone; and
performing a HMAC message authentication using the CHK of the SM, when the SM is in a non-virgin state or when the SM is not moved to the AP zone.

19. The mutual authentication method of claim 12, wherein the first encryption key comprises a first message encryption key and a first SM Client Image encryption key, the first message encryption key and the first SM Client Image encryption key being generated based on the KeyResponse information through the SM, and
the second encryption key comprises a second message encryption key and a second SM Client Image encryption key, the second message encryption key and the second SM Client Image encryption key being generated through the AP.

20. The mutual authentication method of claim 12, further comprising:
transmitting inconsistency information to the SM using the AP, when the first encryption key differs from the second encryption key, the inconsistency information indicating that the first encryption key differs from the second encryption key.
